(19) United States
(12) Patent Application Publication
(10) Pub. No.: US 2014/0076756 A1
(43) Pub. Date: Mar. 20, 2014

(54) SCOOP HOLDER FOR HOLDING A SCOOP DEVICE ADAPTED TO SCOOP CAT LITTER FROM A CAT LITTER BOX AND METHOD OF MANUFACTURING THE SCOOP HOLDER

(71) Applicant: Robert Sweetman, (US)

(72) Inventor: Robert Sweetman, Staten Island, NY (US)

(21) Appl. No.: 13/623,553

(22) Filed: Sep. 20, 2012

(51) Int. Cl. B65D 85/00; B23P 19/04

(52) U.S. Cl. 206/349; 29/428

(57) ABSTRACT

A scoop holder for holding a scoop device for scooping waste-contaminated cat litter from a cat litter box, and a method of manufacturing the scoop holder, is disclosed. The scoop holder includes a receptacle adapted to be coupled to a support structure, such as a side panel of the litter box, a wall, or other vertical structure. The receptacle defines a cavity therein for holding the scoop device. A liner is adapted to line the cavity so as to prevent waste-contaminated litter particles that fall from the scoop device from collecting in the receptacle. In one embodiment, the liner is removable from the receptacle, and is separately cleanable. In another embodiment, the liner is affixed to a liner housing, and is outwardly extendable therefrom for cleaning the liner.

### FIELD OF THE INVENTION

This invention generally relates to cat litter boxes, and more specifically to scoop devices for use with cat litter boxes.

### BACKGROUND OF THE INVENTION

Cat litter boxes are used by cats for elimination of cat waste matter that includes urine and fecal matter. The litter box typically contains a layer of cat litter that receives the cat's waste. The waste, after being deposited in the cat litter, forms clumps, and is typically sifted from the litter box by a user, such as the cat's owner, using a litter scoop with many small holes in its surface. The small holes in the walls allow unclumped litter to sift through the holes in the walls, while keeping the clumped waste on the litter scoop. The clumped waste is then discarded. The cat litter is typically a chemical composition including diatomaceous earth that is 80% to 90% silica (SiO₂), with the remaining constituents being alumina (AlO₃) and iron oxide (Fe₂O₃). Granular size of the cat litter is usually about 0.5 millimeters (0.0197 inch) to about 2 millimeters (0.0787 inch), and density is typically about 0.9 grams per cubic centimeter (56.19 pounds per cubic foot) to about 0.95 grams per cubic centimeter (59.31 pounds per cubic foot). This chemical composition and density for the cat litter allows the cat litter to be absorbent, and facilitates formation of the compact clumps for easier collection and disposal.

However, the cat waste contained in the litter clumps scooped from the litter box may contain organisms harmful to human health, such as escherichia coli bacteria, and toxoplasma gondii protozoa. For example, in the case of cat fecal matter, the harmful organisms may include toxoplasma gondii, which is a parasite acquired by the cat eating infected rodents, birds, or other small animals. Toxoplasma gondii can survive in soil for more that a year, and can also contaminate drinking water. However, most municipal water treatment systems are not designed to filter toxoplasma gondii. Therefore, drinking water may be at risk of being contaminated with toxoplasma gondii, unless precautions are taken to prevent contamination, such as disposal of the cat's waste in a manner avoiding contact with drinking water.

In this regard, it is important that cat waste not enter the biosphere. For example, the previously mentioned toxoplasma gondii poses a health risk to humans, especially those having compromised immune systems caused by disease, such as Acquired Immune Deficiency Syndrome (AIDS). Toxoplasma gondii contamination has also been found in blood used for blood transfusions and organs donated for transplantation. In addition, Toxoplasmosis, which is caused by the toxoplasma gondii parasite, has been linked to birth defects, blindness, and brain damage in children born to infected mothers. Therefore, as a precaution, some state environmental agencies require cat litter packages to bear a warning label instructing cat owners not to flush used cat litter or otherwise dispose of used cat litter in storm drains. For example, in the state of California, U.S.A., cat litter sold in the state must carry a warning label stating the dangers of toxoplasmosis to humans, and cat owners caught flushing used cat litter are subject to fines of up to $25,000. To comply with state law, used cat litter is preferably placed in plastic bags, and put in household trash that is subsequently collected and deposited in a landfill. Consequently, it is important that used cat litter be discarded in an environmentally safe, sanitary, and lawful manner.

As explained above, the litter scoop is used to scoop and sift litter clumps from the cat litter box. However, after using the litter scoop, the scoop becomes contaminated with litter and cat waste. In particular, at least the scoop end of the litter scoop becomes covered by a plurality of waste-contaminated cat litter micro-particles. Merely placing the litter scoop on the floor next to the cat litter box increases the risk that waste-contaminated litter particles will be transferred to the floor, and then be tracked into adjacent rooms due to feline and/or human foot traffic, and other human and cat activity. The tracked litter may be contaminated with the previously mentioned bacteria (e.g., escherichia coli) and protozoa (e.g., toxoplasma gondii) that can cause or exacerbate health issues in some humans. Therefore, a litter scoop holder may be provided to avoid the need to place the litter scoop on the floor after use. Avoiding the need to place the litter scoop on the floor reduces the risk that contaminated litter particles will be tracked into adjacent rooms, and then possibly also deposited onto furniture surfaces.

When the litter scoop is placed in the litter scoop holder after use, the litter scoop will nonetheless have the previously mentioned plurality of residual waste-contaminated litter particles adhering thereto. In a relatively short time, after just a few litter scoop uses, these waste-contaminated litter particles fall from the litter scoop to collect at the bottom of the litter scoop holder. Repeated use of the litter scoop and litter scoop holder in this manner typically results in a relatively substantial accumulation of waste-contaminated litter at the bottom of the litter scoop holder. Substantial accumulation of waste-contaminated litter at the bottom of the litter scoop holder poses a health risk to the user. This is so because the user may inadvertently inhale fine particles of contaminated litter dust emanating from the accumulated litter in the litter scoop holder, or otherwise inadvertently come into contact with the waste-contaminated litter in the litter scoop holder. Consequently, although it is desirable to provide the litter scoop holder, allowing the contaminated litter to accumulate in the litter scoop holder poses a health risk.

Therefore, for the health reasons mentioned hereinabove, it is important to periodically empty waste-contaminated litter particles from the litter scoop holder, and thereafter properly dispose of the contaminated litter particles. However, some cat owners postpone emptying litter scoop holders because doing so is an inconvenience. In this regard, some known litter scoop holders are not conveniently and readily accessible so as to encourage the cat owner to empty the litter scoop holder and properly dispose of the used cat litter on a regular basis. Also, some known litter scoop holders require extensive handling of the litter scoop holder, also requiring disassembly and reassembly in order to empty the litter scoop holder. Requiring extensive handling, disassembly, and reassembly of the litter scoop holder discourages cat owners from emptying the litter scoop holder on a sufficiently frequent basis.

Attempts have been made to address the considerations mentioned hereinabove with respect to use of litter scoop holders for storage of cat litter scoops. For example, U.S. Patent Application Publication No. US 2007/0075203 A1 titled “Cat Litter Scoop Holder” and published Apr. 5, 2007 in the name of Patrick Joseph Conlin relates to a holder for a litter scoop, the holder being mountable on a barrier surface such as a wall or a door. The holder has a releasable and remountable receptacle that holds the litter scoop and that can be periodically emptied of cat litter particles.

According to Conlin, a support member of a litter scoop holder assembly includes a securing aperture to secure the support member to a barrier surface using nails, screws, or the like. If desired, adhesive, hook-and-loop fasteners, or other suitable fastening elements, rather than nails and screws, can be used to secure the support member to the barrier surface. The support member contains a plurality of apertures for receiving flanged knobs that extend outwardly from a litter scoop receptacle. A proximal wall of the receptacle may form a concave pocket that receives a litter scoop. The receptacle is removably mounted on the support member by inserting the flange portion of the knobs into the apertures and applying downward pressure on the receptacle until the flange portions engage each of the apertures. The receptacle is releasable from the support member by lifting the receptacle upward and outward and removing the flange portions from the apertures, for ease in cleaning of the support member and receptacle.

Conlin discloses that the receptacle can be cleaned after being released from the support member. However, as seen in the several figures of this published patent application, the receptacle appears to have only three side walls. The support member apparently provides a fourth side wall only when the receptacle is connected to the support member. Therefore, it appears that one side of the receptacle is open after the receptacle is released from the support member for cleaning. However, the open side of the receptacle may allow contaminated litter particles to escape and fall to the floor or other nearby surface after the receptacle is released from the support member. Allowing contaminated litter particles to escape and fall to the floor or other nearby surface increases the health risk to the individual handling the receptacle.

Another attempt to address the considerations mentioned hereinabove with respect to use of scoop holders for storage of cat litter scoops is disclosed in U.S. Pat. No. 6,578,807 B1, titled “Cat Litter Scoop Holder And Scoop”, and issued Jun. 17, 2003 in the name of John M. Lipscomb, et al. This patent relates generally to a cat litter scoop and holder therefor, as well as to a combination of a cat litter scoop and a cat litter scoop holder.

According to Lipscomb, et al., a cat litter scoop holder releasably receives and retains a cat litter scoop in a pocket in the holder. The holder includes a base upon which it can rest in an upright orientation on a horizontal surface, such as a floor or countertop, and can be easily moved, according to this patent. The base can include a larger pedestal that provides stability to help the holder resist tipping when it is placed on the horizontal surface. Extending upwardly from the base is a retainer wall and a rear wall that is spaced from the retainer wall, thereby defining the scoop receiving pocket therebetween. In one preferred embodiment, the holder also includes a bracket that can be used to mount the holder to a vertical surface, such as a wall. The scoop-receiving pocket preferably includes a collection trough that preferably is of perforate construction to permit matter from a scoop received in the scoop receiving pocket to sift from the scoop pocket. In one preferred embodiment, the collection trough includes a pair of sidewalls spaced apart by a bottom wall that provides increased volume to hold matter from the scoop while still permitting the scoop to properly seat in the holder. The bottom of the holder preferably is hollow and defines a retention chamber that helps collect matter from the scoop that has sifted through from the scoop receiving pocket. The holder can be periodically lifted, and the surface below the holder can be cleaned.

Although the Lipscomb, et al. patent teaches that the holder defines a retention chamber that collects matter from the scoop, and that the space below the holder can be periodically cleaned, cat fecal matter is nonetheless allowed to directly contact and collect in the holder itself before the holder is cleaned. Also, to clean the holder, the user thereof apparently must manipulate the entire holder, such as by unattaching and removing the entire holder from the wall, or by extensively manipulating the entire holder when the holder is positioned on a horizontal surface, which presents a substantial inconvenience for the user of the holder.

Yet another attempt to address the considerations mentioned hereinabove with respect to use of scoop holders for storage of cat litter scoops is disclosed in U.S. Pat. No. 5,460,293, titled “Cat Litter Scoop Containers” and issued Oct. 24, 1995 in the name of Kurt D. Erickson. This patent relates to storing a cat litter scoop in a conveniently located, tightly sealed holder to prevent odors from entering surrounding living areas. According to Erickson, the cat litter scoop container includes a holder formed as a generally rectangular shaped hollow box. The holder has a roof, a floor, a long rear wall, two long sidewalls, and an open front. Generally cylindrical shaped projections form a hinge to permit rotational opening and closing of a front cover so as to allow storing the cat litter scoop in the holder. In this regard, the hinge is positioned between the holder and front cover, and is affixed to both so as to permit the rotational opening and closing of the front cover. A replaceable charcoal filter is positioned within brackets of the cover to allow fresh air into the holder while preventing odor from escaping.

However, Erickson is silent on the issue of cleaning the holder. In fact, this patent appears to be directed to merely preventing escape of odor from used cat litter in the holder.

### SUMMARY OF THE INVENTION

The present invention provides a scoop holder for holding a scoop device that is adapted to scoop cat litter from a cat litter box, and a method of manufacturing the scoop holder. The scoop holder includes a receptacle adapted to be coupled to a support structure, which may be a conventional cat litter box or wall. The receptacle is coupled to the support structure by an attachment arrangement, which may be adhesive tape, a hook-and-loop fastener, a screw fastener assembly, or a mounting bracket. Alternatively, the receptacle may be integrally formed with the litter box, so that the litter box and receptacle are a single unit. In all cases, the receptacle is located for convenient access by the user of the scoop holder and litter scoop device.

After use, the litter scoop device is placed for storage in a cavity defined by the receptacle. However, a liner is provided between the litter scoop device and the receptacle so as to prevent litter particles that fall from the litter scoop device from contacting the inner surfaces of the receptacle and collecting in the receptacle. The liner may be substantially rigid and box-shaped to matingly fit within the receptacle, or the liner may be a flexible bag that conforms to the inner shape of the receptacle. In either case, the liner prevents the litter particles from contacting the interior surfaces of the receptacle.

In one configuration of the invention, the rigid and flexible liners are both removable. In another configuration of the invention, the flexible liner is reusable and has an open end portion thereof attached to an open top end portion of the receptacle. The remainder of the reusable flexible liner remains unattached inside the receptacle. In order to empty the contaminated cat litter from the reusable flexible liner, a user of the scoop holder outwardly pulls the reusable flexible liner from the cavity defined by the receptacle so as to invert the liner, thereby exposing the inside of the reusable flexible liner to an area outside the cavity. Once outside the cavity, but still attached to the open top end of the receptacle, the exposed inside of the reusable flexible liner can be cleaned. After cleaning, the reusable flexible liner is un-inverted and pushed back into the cavity defined by the receptacle.

The scoop holder of the invention is easily cleanable without disassembling or disconnecting the scoop holder from the support structure, and thereafter reassembling or reconnecting the scoop holder to the support structure. Rather, a removable liner is used to collect waste-contaminated cat litter particles falling from the litter scoop device when the litter scoop device is in the receptacle. The liner is subsequently removed from the receptacle, so that the liner can be conveniently emptied of the cat litter particles and cleaned. In other words, the liner is easily removed from the receptacle of the scoop holder for cleaning, and then is replaced back into the receptacle. Alternatively, the liner can remain attached to the receptacle. In this case, the receptacle is manually turned upside down, and the liner is pulled inside-out from the receptacle, so that the liner can be emptied of litter particles and cleaned. The liner is then pushed back into the receptacle. As yet another alternative, the liner can be removed from the receptacle of the scoop holder, discarded, and then replaced with an unused or fresh liner. Moreover, it will be appreciated that the scoop holder is readily accessible by the user because the scoop holder is connected to the cat litter box, or to a wall near the cat litter box.

In addition, the previously mentioned flexible liner has an open end that is closeable, such as by a tie-string. This feature of the invention allows the flexible liner to be substantially sealed after waste-contaminated litter is received therein. Allowing the flexible liner to be substantially sealed reduces risk of contaminated litter being dispersed into the biosphere and possibly entering drinking water supply systems. Also, allowing the flexible liner to be substantially sealed and placed into household trash for subsequent disposal in a landfill complies with many state laws governing proper disposal of cat litter.

Thus, the scoop holder of the present invention is more sanitary, is less complicated to use than conventional scoop holders, has no mechanical moving parts that can malfunction, is readily accessible, and is more convenient to use. In addition, the scoop holder of the present invention facilitates compliance with many state laws regarding proper disposal of cat litter.

A general aspect of the invention is a scoop holder for holding a scoop device for scooping waste-contaminated cat litter from a cat litter box. The scoop holder includes: a receptacle capable of being coupled to a support structure, the receptacle defining a cavity therein for holding the scoop device; and a liner adapted to line the cavity of the receptacle, thereby preventing litter particles that fall off of the scoop device from collecting in the cavity of the receptacle.

In some embodiments, the liner is removable and separately cleanable.

In some embodiments, the liner is a rigid box having an open top end portion for receiving the scoop holder through the open top end portion.

In some embodiments, the scoop holder further includes an attachment arrangement adapted to couple the receptacle to the support structure. In some of these embodiments, the attachment arrangement includes adhesive tape. In other of these embodiments, the attachment arrangement includes a hook-and-loop fastener. In yet other of these embodiments, the attachment arrangement includes a screw fastener assembly. In still other of these embodiments, the attachment arrangement includes a mounting bracket. In further embodiments, the attachment arrangement includes at least one stud attached to the mounting bracket. In still further embodiments, the receptacle defines at least one slot therein sized to slidably engage the at least one stud for slidably coupling the receptacle to the mounting bracket. In other of these embodiments, the attachment arrangement includes: a mounting plate; and at least one sanitation accessory coupled to the mounting plate for reducing odor emanating from the plurality of litter particles, and for cleaning the receptacle.

In some embodiments, the receptacle is integrally formed with the support structure for defining a single unit including the receptacle and the support structure.

In some embodiments, the liner has a plurality of walls having respective ones of a plurality of recesses formed therein; and the receptacle has a plurality of walls having respective ones of a plurality of detents formed therein, the plurality of detents being releasably engageable with respective ones of the plurality of recesses for releasably coupling the liner to the receptacle.

In some embodiments, the liner is a flexible bag having an openable and closeable top end portion for receiving and removing the scoop device through the top end portion when the top end portion is open, and for enclosing the plurality of litter particles therein when the top end portion is closed.

In some embodiments, the receptacle has a top end marginal edge portion, the liner is a flexible bag having an open top end portion attached to the top end marginal edge portion of the receptacle, and the liner has a closed bottom end portion locatable in a first position within the cavity defined by the receptacle, and the liner is outwardly extendable from the first position to a second position outside the cavity.

In some embodiments, the support structure is one of: a side panel of the cat litter box, and a wall near the cat litter box.

Another general aspect of the invention is a scoop holder for holding a scoop device for scooping cat litter from a cat litter box, the scoop holder including a receptacle adapted to be coupled to a side panel of the cat litter box, the receptacle defining a cavity therein for holding the scoop device; a liner adapted to line the cavity of the receptacle, the liner being for preventing a plurality of waste-contaminated litter particles from collecting in the receptacle due to the receptacle holding the scoop device, the liner being removable and separately cleanable; and a coupler adapted to couple the receptacle to the side panel of the cat litter box.

Another general aspect of the invention is a method of manufacturing a scoop holder for holding a scoop device adapted to scoop cat litter from a cat litter box, the method including: forming a receptacle adapted to be coupled to a support structure, the receptacle defining a cavity therein for holding the scoop device; and providing a liner adapted to line the cavity of the receptacle for preventing a plurality of litter particles that fall from the scoop device from collecting in the receptacle as the scoop device is held by the receptacle.

In some embodiments, providing the liner includes providing a box-shaped liner.

In some embodiments, the method further includes providing an attachment arrangement for coupling the receptacle to the support structure.

In addition to the foregoing, various other method and/or device aspects and features are set forth and described in the teachings, such as text (e.g., claims and/or detailed description) and/or drawings of the present invention.

The foregoing is a summary and thus may contain simplifications, generalizations, inclusions, and/or omissions of detail. Consequently, those skilled in the art will appreciate that the summary is illustrative only and is not intended to be in any way limiting. In addition to the illustrative aspects, embodiments, and features described hereinabove, further aspects, embodiments, and features will become apparent by reference to the drawings and the following detailed description.

### BRIEF DESCRIPTION OF THE DRAWINGS

The invention will be more fully understood by reference to the detailed description in conjunction with the following figures, wherein:

FIG. 1 is a fragmentary view in perspective of a first embodiment litter scoop holder coupled to a cat litter box, or to a wall near the cat litter box, the litter scoop holder including a box-shaped receptacle and a box-shaped first configuration liner matingly disposed in the receptacle;

FIG. 2 is a view in elevation of the first embodiment litter scoop holder coupled to the cat litter box;

FIG. 3 is a view taken along section line 3-3 of FIG. 2, this view showing the first embodiment litter scoop holder coupled to the cat litter box by means of a double-sided adhesive tape;

FIG. 4 is a view in vertical section of the cat litter box and the first embodiment litter scoop holder, the first embodiment litter scoop holder being coupled to the cat litter box by means of an adhesive layer;

FIG. 5 is a view in perspective of the first configuration liner removed from the receptacle;

FIG. 6 is a view in perspective of the first configuration liner being manually inverted by a user thereof to empty a multiplicity of waste-contaminated litter particles therefrom;

FIG. 7 is a view in vertical section of the cat litter box and litter scoop holder coupled thereto by means of a hook-and-loop fastener, a male member thereof adhesively coupled to the receptacle and a female member thereof adhesively coupled to the cat litter box;

FIG. 8 is a view in vertical section of the cat litter box and litter scoop holder coupled thereto by means of a hook-and-loop fastener, a male member thereof adhesively coupled to the liner and a female member thereof adhesively coupled to the cat litter box, so that the receptacle is eliminated;

FIG. 9 is a view in perspective of the cat litter box and litter scoop holder coupled thereto by means of a screw fastener assembly;

FIG. 10 is a view in elevation of the cat litter box and litter scoop holder coupled thereto by means of the screw fastener assembly;

FIG. 11 is a view taken along section line 11-11 of FIG. 10;

FIG. 12 is a view taken along section line 12-12 of FIG. 10;

FIG. 13 is a fragmentary view in perspective of a mounting bracket adapted to couple the receptacle to the cat litter box;

FIG. 14 is a view in vertical section of the mounting bracket coupling the receptacle to the cat litter box;

FIG. 15 is a view in elevation of a mounting plate coupled to the cat litter box, the mounting plate having the receptacle and at least one sanitation accessory coupled to the mounting plate;

FIG. 16 is a view taken along section line 16-16 of FIG. 15, this view showing the receptacle coupled to the mounting plate and the mounting plate coupled to the cat litter box by means of double-sided adhesive tape;

FIG. 17 is a view in elevation of the mounting plate coupled to the cat litter box by a plurality of screw fasteners, the mounting plate having the receptacle and the at least one sanitation accessory coupled to the mounting plate;

FIG. 18 is a view taken along section line 18-18 of FIG. 17;

FIG. 19 is a view in vertical section of the receptacle integrally attached to the cat litter box, such that the receptacle and cat litter box form a single unit;

FIG. 20 is a view in elevation of a second embodiment litter scoop holder including an alternative receptacle having an open front and a second configuration liner disposed in the alternative receptacle;

FIG. 21 is a fragmentary view in vertical section taken along section line 21-21 of FIG. 20, this view showing the second embodiment litter scoop holder having the second configuration liner disposed therein;

FIG. 22 is a view in perspective of a third configuration liner disposed in the box-shaped receptacle, the third configuration liner being a flexible bag;

FIG. 23 is a fragmentary view in perspective of a fourth configuration liner being emptied of waste-contaminated cat litter particles; and

FIG. 24 is a flowchart showing an illustrative method of manufacturing a scoop holder for holding a scoop device adapted to scoop cat litter from a cat litter box.

### DETAILED DESCRIPTION OF PREFERRED EMBODIMENTS

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from either the spirit or scope of the invention.

In addition, the present patent specification uses formal outline headings for clarity of presentation. However, it is to be understood that the outline headings are for presentation purposes, and that different types of subject matter may be discussed throughout the application (e.g., device(s)/structure(s) may be described under process(es)/operations heading(s) and/or process(es)/operations may be discussed under structure(s)/process(es) headings; and/or descriptions of single topics may span two or more topic headings). Hence, the use of the formal outline headings is not intended to be in any way limiting.

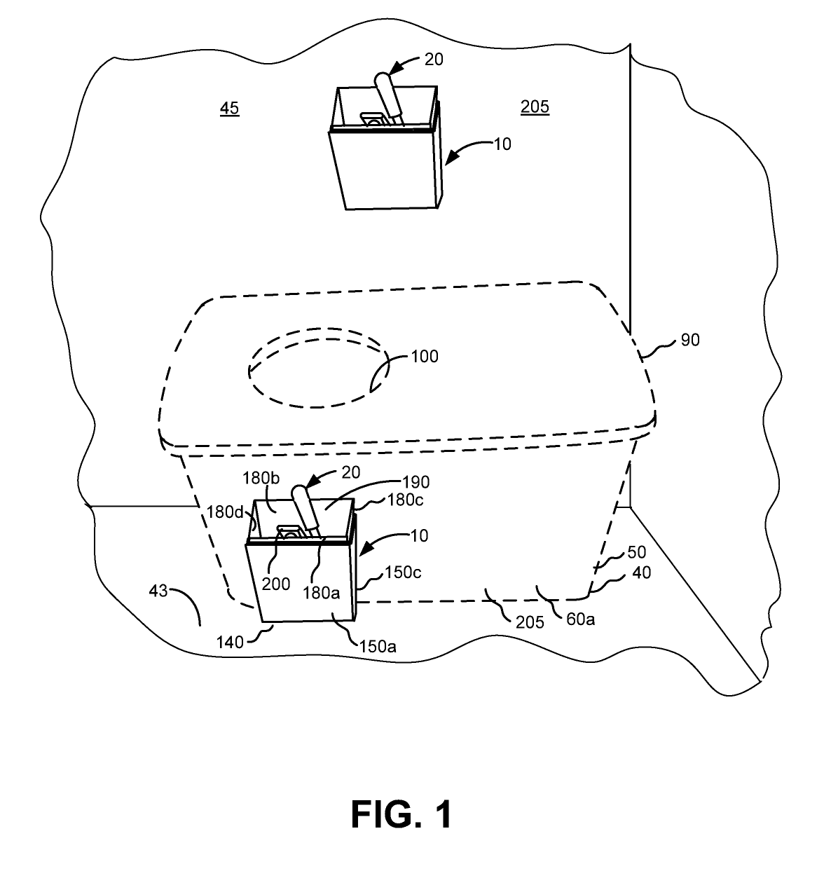

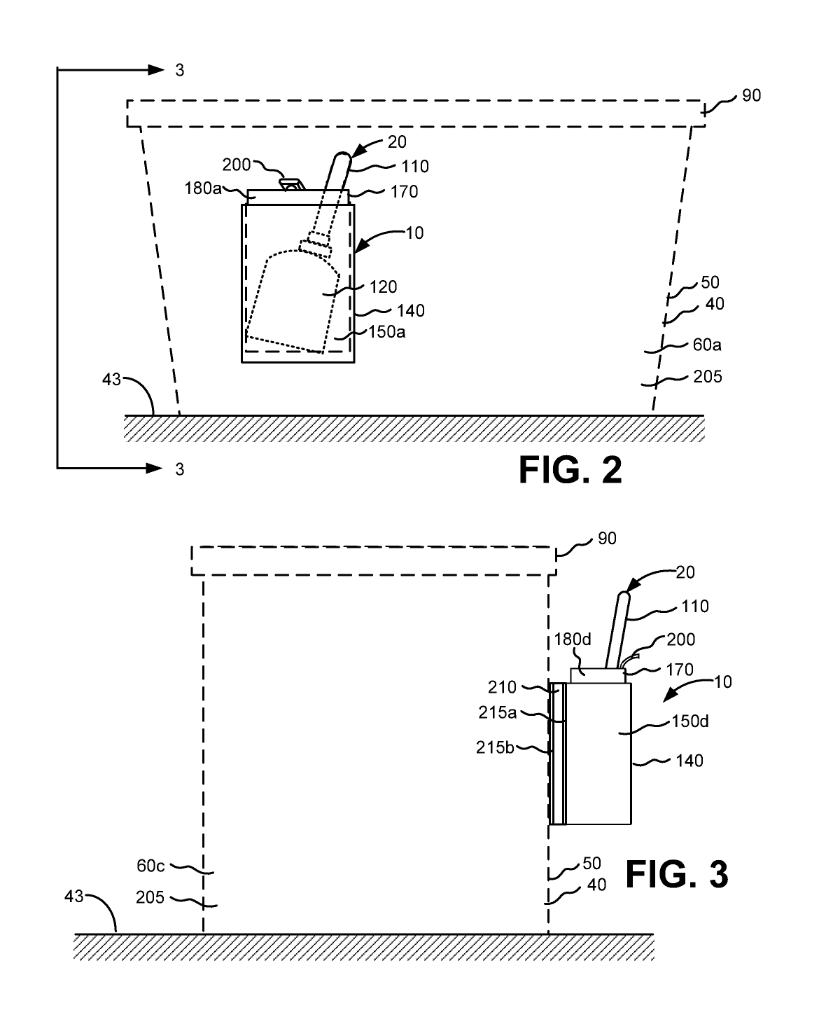

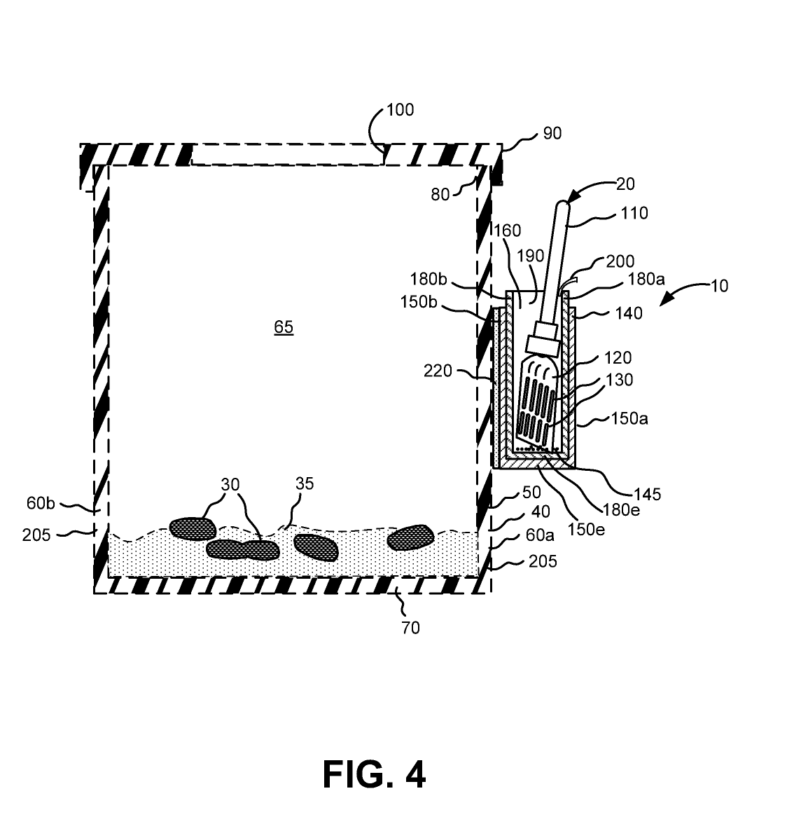

Therefore, with reference to FIGS. 1, 2, 3, and 4, there is shown a first embodiment litter scoop holder, generally referred to as 10, for holding a litter scoop device, generally referred as 20, that is adapted to sift, rake or scoop a plurality of cat litter clumps 30 from cat litter 35 disposed in a cat litter box 40. Cat litter clumps 30 contain cat biological waste matter (i.e., urine soaked litter and feces). Cat litter box 40 may be located at any suitable location, such as on a floor 43, on a counter top (not shown) or similar horizontal surface. A conventional, commercially available cat litter box 40 suitable for this purpose may be of a type, such as a “CLEVERCAT® TOP ENTRY CAT LITTER BOX”, that may be available from Clevercat Innovations, Inc. located in Sarasota, Fla., U.S.A. The “CLEVERCAT® TOP ENTRY CAT LITTER BOX”, or similar litter box construction, comprises a base portion 50 having four substantially vertical, perpendicularly arranged, integrally connected side panels 60a, 60b, 60c (only three of the four side panels are shown). Litter box 40 also includes a horizontal bottom panel 70 integrally formed with side panels 60a, 60b, 60c and the fourth side panel, so as to define an interior volume 65 of litter box 40. Bottom panel 70 supports litter clumps 30 and cat litter 35 thereon while litter clumps 30 and cat litter 35 are disposed in litter box 40. Litter box 40 has an open top end 80 for placement of cat litter 30 in litter box 40 and for removal of litter clumps 30 that contain the cat biological waste matter. Mounted atop open top end 80 is a removable lid or cover 90. Cover 90 allows access to litter clumps 30 and cat litter 35 that is disposed in interior volume 65 of litter box 40 when cover 90 is removed and encloses litter clumps 30 and cat litter 35 in interior 65 when cover 90 is mounted atop open top end 80. Cover 90 defines an opening 100 for a cat (not shown) to enter and leave litter box 40.

Referring again to FIGS. 1, 2, 3, and 4, such conventional, commercially available cat litter boxes 40 may be made of any suitable material, such as polypropylene, acrylonitrile butadiene styrene (ABS), nylon, acetone or resin. However, according to the teachings herein, the material composition constituting such a conventional, commercially available litter box 40 can be enhanced. In this regard, the material comprising cat litter box 40 may include a pathogen resistant, antimicrobial, antifungal composition, such as the “VINYZENE™ IT 3025 DOTP ANTIMICROBIAL” composition that may be available from The Dow Chemical Company located in Midland, Mich., U.S.A. The “VINYZENE™ IT 3025 DOTP ANTIMICROBIAL” composition comprises a solution of 2-n-octyl-4-isothiazolin-3-one in a nonvolatile phthalate-free carrier that can be added to the plastic composition comprising litter box 40 during manufacture of litter box 40. Alternatively, litter box 40 may be made of metal, such as steel or aluminum. In this case, the metal may be coated, layered or otherwise painted with a pathogen resistant, antimicrobial, antifungal composition, such as a composition having silver (Ag) as an active ingredient. Such a coating containing silver and that is suitable for this purpose may be of a type, such as the “AGION” compound, that may be available from AgION® Technologies, Incorporated located in Wakefield, Mass., U.S.A. The “AGION” compound combines silver with an inorganic ceramic that permits a continuous, controlled release of ionic silver over an extended time period in such a manner that inhibits growth of microbes. Inhibiting growth of microbes, whether litter box 40 is formed of plastic or metal, is important in order to help maintain litter box 40 in a sanitary condition, so that risk to human health is reduced.

Cat litter 35 is selected from any of the known cat litter compositions. However, a type of cat litter 35 that is preferred by many cat owners is “clumping litter.” Clumping litter may comprise bentonite clay (absorbent aluminum phyllosilicate) or diatomaceous earth, which forms a relatively solid mass or clump 30 when wet. Any clumps 30 can then be scooped, raked or otherwise sifted from cat litter 35 that is disposed in litter box 40 without emptying the entire contents of litter box 40.

Previously mentioned litter scoop device 20, which forms no part of the present invention, is used to sift, rake or scoop clumps 30 from cat litter 35 that are disposed in litter box 40. In this regard, litter scoop device 20 comprises an elongate handle 110 attached to a perforate blade member 120. More specifically, blade member 120 defines a plurality of perforations 130 therethrough sized to allow unclumped litter material to pass through perforations 130 while simultaneously retaining waste litter clumps 30 on blade member 120. Litter clumps 30 are subsequently discarded, such as in the manner described hereinbelow.

Referring again to FIGS. 1, 2, 3 and 4, first embodiment litter scoop holder 10 comprises a box-shaped first embodiment receptacle 140 that includes a vertical front sidewall 150a and a vertical rear sidewall 150b oppositely disposed with respect to front sidewall 150a and spaced-apart therefrom. Receptacle 140 further includes a vertical right sidewall 150c and a vertical left sidewall 150d oppositely disposed with respect to right sidewall 150c and spaced-apart therefrom. Right sidewall 150c and left sidewall 150d are each perpendicular to front sidewall 150a and rear sidewall 150b and integrally attached thereto. Also, a horizontal bottom wall 150e is integrally attached to bottom end portions of sidewalls 150a, 150b, 150c and 150d. In this manner, box-shaped receptacle 140 defines an open cavity 160 therein for holding litter scoop device 20.

Referring yet again to FIGS. 1, 2, 3 and 4, receptacle 140 may be made of any convenient material or composition. For example, the material comprising receptacle 140 may include polypropylene, acrylonitrile butadiene styrene (ABS), nylon, acetone, resin or the like. Also, the material comprising receptacle 140 may include a pathogen resistant, antimicrobial, antifungal composition, such as the previously mentioned “VINYZENE™ IT 3025 DOTP ANTIMICROBIAL” composition. Alternatively, receptacle 140 may be made of metal, such as steel or aluminum. In this case, the metal may be coated, layered or otherwise painted with a pathogen resistant, antimicrobial, antifungal composition, such as a composition having silver (Ag) as an active ingredient. The previously mentioned “AGION” compound may be provided for this purpose. Use of such pathogen resistant, antimicrobial, antifungal compositions assists in maintaining receptacle 140 in a sanitary condition for reducing the health risk to the user and others who may contact receptacle 140.

As previously indicated, it is important that receptacle 140 be maintained in a sanitary condition. However, even after clumps 30 are collected and discarded, a multiplicity of litter particles 145 may still remain on blade member 120, such as in and around perforations 130, when litter scoop device 20 is stored in receptacle 140. These litter particles 145 will fall from litter scoop 20, contact interior surfaces of sidewalls 150a, 150b, 150c, 150d and bottom wall 150e and, over time, may substantially accumulate within cavity 160 that is defined by receptacle 140. Litter particles 145 pose a health risk to the user and others. Hence, it is desirable that contaminated litter particles 145 not contact the interior surfaces of receptacle 140 and, over time, substantially accumulate within cavity 160. As described in detail hereinbelow, litter scoop holder 10 is configured to avoid contact of contaminated litter particles 145 with interior surfaces of receptacle 140. In addition, as described in detail hereinbelow, litter scoop holder 10 is configured to make it convenient for the user to empty litter particles 145 from litter scoop holder 10, so that the user is encouraged to empty litter particles 145 on a frequent basis, rather than on an infrequent basis, in order to reduce the above-recited health risks.

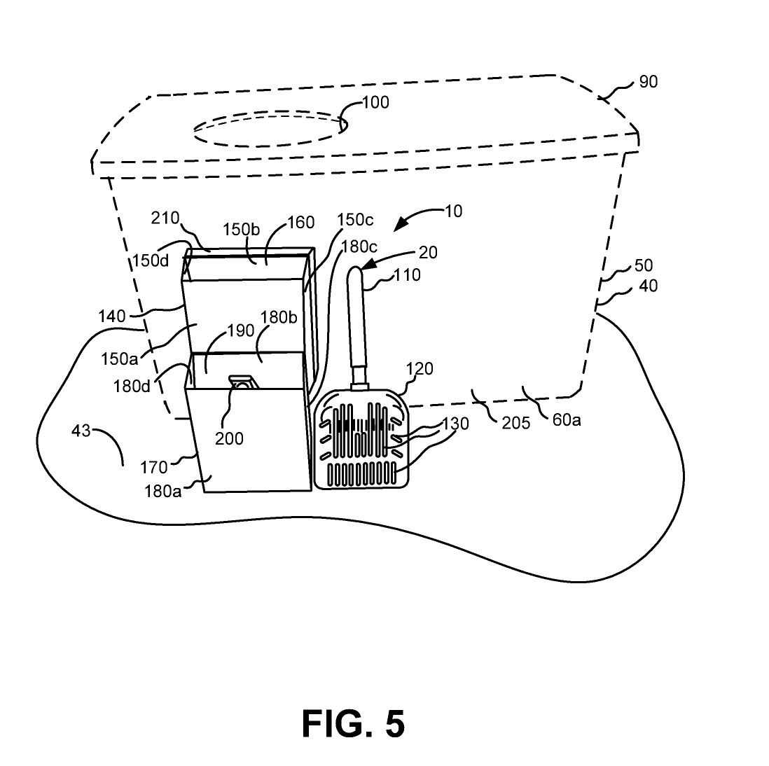

Therefore, referring to FIGS. 1, 2, 3, 4 and 5, a rigid, box-shaped first configuration liner 170 is provided that is adapted to line cavity 160 of receptacle 140 for preventing plurality of litter particles 145 that fall from litter scoop device 20 from contacting and collecting within receptacle 140 as litter scoop holder 10 holds litter scoop device 20. Liner 170 includes a vertical front wall 180a and a vertical rear wall 180b oppositely disposed with respect to front wall 180a and spaced-apart therefrom. Liner 170 further includes a vertical right wall 180c and a vertical left wall 180d oppositely disposed with respect to right wall 180c and spaced-apart therefrom. Right wall 180c and left wall 180d are each perpendicular to front wall 180a and rear wall 180b and integrally attached thereto. Also, a horizontal bottom wall 180e is integrally attached to bottom end portions of walls 180a, 180b, 180c and 180d. In this manner, box-shaped liner 170 defines an open interior volume 190 therein for holding litter scoop device 20. Moreover, it should be appreciated by a person or ordinary skill in the art that liner 170 is interposed between the interior surfaces of receptacle 140 and litter scoop device 20, so that litter particles 145 falling from blade member 120 of litter scoop device 20 do not contact and accumulate on the interior surfaces of receptacle 140. Liner 170 further includes a tab 200 attached thereto for conveniently allowing manual removal of liner 170 from cavity 160 of receptacle 140 for cleaning or for disposal. Thus, liner 170 is matingly received within receptacle 140 and is also easily and readily removable and separately cleanable.

Referring again to FIGS. 1, 2, 3, 4, and 5, liner 170 may be made of any suitable material, such as polypropylene, acrylonitrile butadiene styrene (ABS), nylon, acetone, resin or the like. Also, the material comprising liner 170 may include a pathogen resistant, antimicrobial, antifungal composition, such as the previously mentioned “VINYZENE™ IT 3025 DOTP ANTIMICROBIAL” composition. Alternatively, liner 170 may be made of metal, such as steel or aluminum. In this case, the metal may be coated, layered or otherwise painted with a pathogen resistant, antimicrobial, antifungal composition, such as a composition having silver (Ag) as an active ingredient. The previously mentioned “AGION” compound may be provided for this purpose. Use of such pathogen resistant, antimicrobial, antifungal compositions assists in maintaining liner 170 in a sanitary condition for reducing the health risk to the user and others who may contact liner 170.

Referring to FIGS. 1, 2, 3, 4, 5 and 6, receptacle 140 is affixed to any of the side panels belonging to cat litter box 40, such as side panels 60a, 60b, or 60c, so that receptacle 140 is conveniently accessible by the user. Alternatively, receptacle 140 may be attached to previously mentioned wall 45. Thus, the side panels belonging to cat litter box 40, such as side panels 60a, 60b, or 60c, or wall 45 provide support structure for supporting receptacle 140 thereon.

Referring again to FIGS. 1, 2, 3, 4, 5 and 6, receptacle 140 is coupled either to side panels 60a, 60b, 60c, wall 45 or similar structure (hereinafter collectively referred to as “support structure 205”) by a first embodiment attachment arrangement, which is a double-sided tape 210. More specifically, a first adhesive side 215a of double-sided tape 210 is coupled to receptacle 140 and a second adhesive side 215b of double sided tape 210 is coupled to support structure 205. Such a double-sided tape 210 may be a “3M™ HIGH STRENGTH DOUBLE SIDED TAPE WITH ADHESIVE 300LSE” tape that may be commercially available from the 3M Company located in Saint Paul, Minn., U.S.A. The “3M™ HIGH STRENGTH DOUBLE SIDED TAPE WITH ADHESIVE 300LSE” includes an acrylic adhesive and provides high bond strength to many surfaces, such as plastics including polypropylene. Alternatively, if desired, double-sided tape 210 may be omitted and only a suitable adhesive layer 220 may be applied to either or both of receptacle 140 and support structure 205 in order to couple receptacle 140 to support structure 205. The adhesive components of double-sided tape 210 and adhesive layer 220 may comprise high strength permanent adhesives. Rather than using high strength permanent adhesives, the adhesive components of double-sided tape 210 and adhesive layer 220 may comprise peelable, non-permanent adhesives, so that receptacle 140 may be peeled away or easily separated from support structure 205 when desired. It may be desirable to have receptacle 140 peeled away or easily separated from support structure 205 should receptacle 140 need replacement due to damage or deterioration caused by extensive use. Such a peel-away adhesive suitable for this purpose can be an epoxy adhesive. It should be appreciated that double-sided tape 210 and adhesive layer 220 allow receptacle 140 to be marketed and sold separately from cat litter box 40. In other words, receptacle 140 can be separately marketed and sold as an accessory for semi-permanent attachment to cat litter box 40.

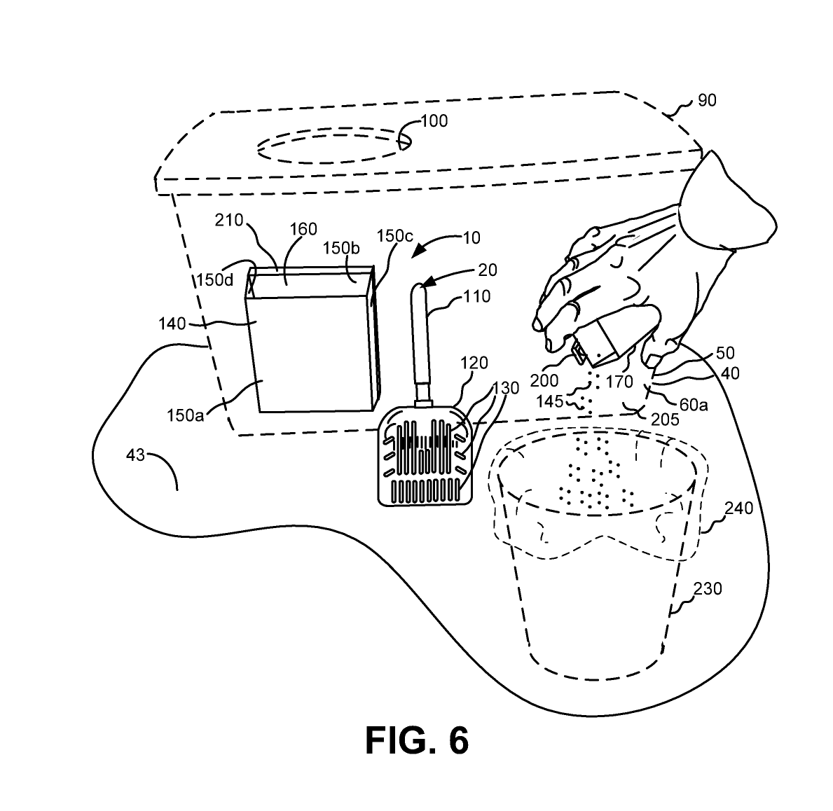

With respect to FIG. 6, it should be appreciated that particles 145 are discarded in a manner that reduces the health risk to the user and that complies with applicable state laws. In order to obtain this result, liner 170 is manually retrieved from receptacle 140 and inverted over a waste container 230 to allow particles 145 to fall from liner 170 and into waste container 230. The waste container 230 is lined with a plastic or paper sheet 240 to capture particles 145 as particles 145 fall into waste container 230. Sheet 240 is subsequently closed and placed in a location for trash pick-up and transportation to a landfill (not shown) or incinerator (also not shown) for proper disposal. Waste container 230 and sheet 240 form no part of the present invention.

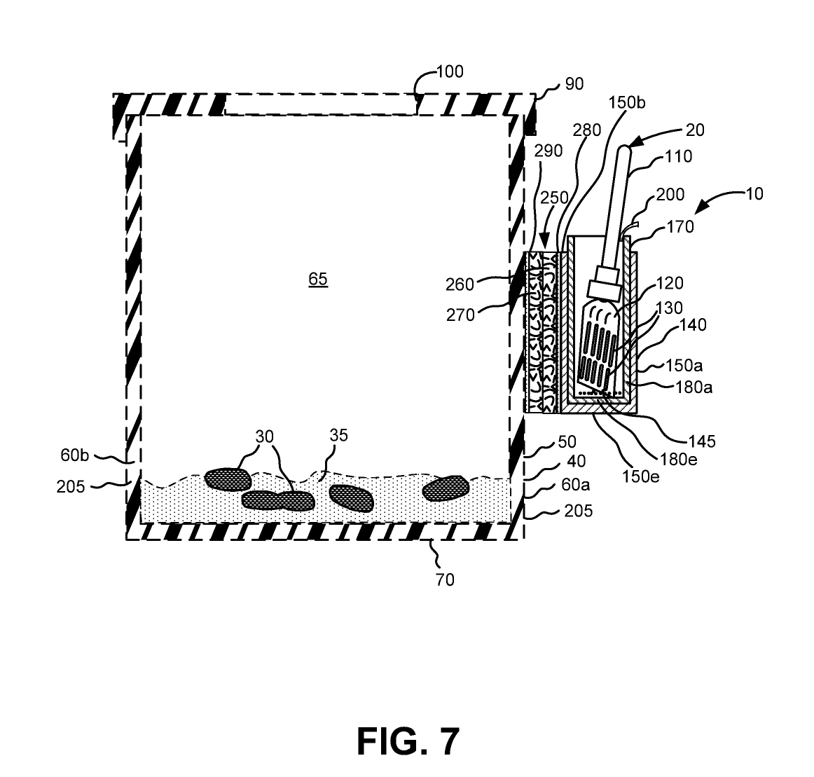

Turning now to FIG. 7, there is shown a second embodiment attachment arrangement, generally referred to as 250, for coupling receptacle 10 to support structure 205. Second embodiment attachment arrangement 250 comprises a hook-and-loop fastener having a male kook member 260 for intimately engaging a female loop member 270. Male hook member 260 includes a first adhesive backing 280 thereon for attaching male hook member 260 to rear sidewall 150b of receptacle 140. Female loop member 270 includes a second adhesive backing 290 thereon for attaching female loop member 270 to support structure 205. The adhesive composition comprising first adhesive backing 280 and second adhesive backing 290 may be a rubber-based adhesive suitable for use on polyethylene and polypropylene surfaces. In this manner, receptacle 140 is removably coupled to cat litter box 40 due to the releasable engagement of male hook member 260 and female loop member 270. The hook-and-loop fastener may be a “VELCRO® brand fastener” that is available from Velcro Industries B.V. located in Amsterdam, The Netherlands.

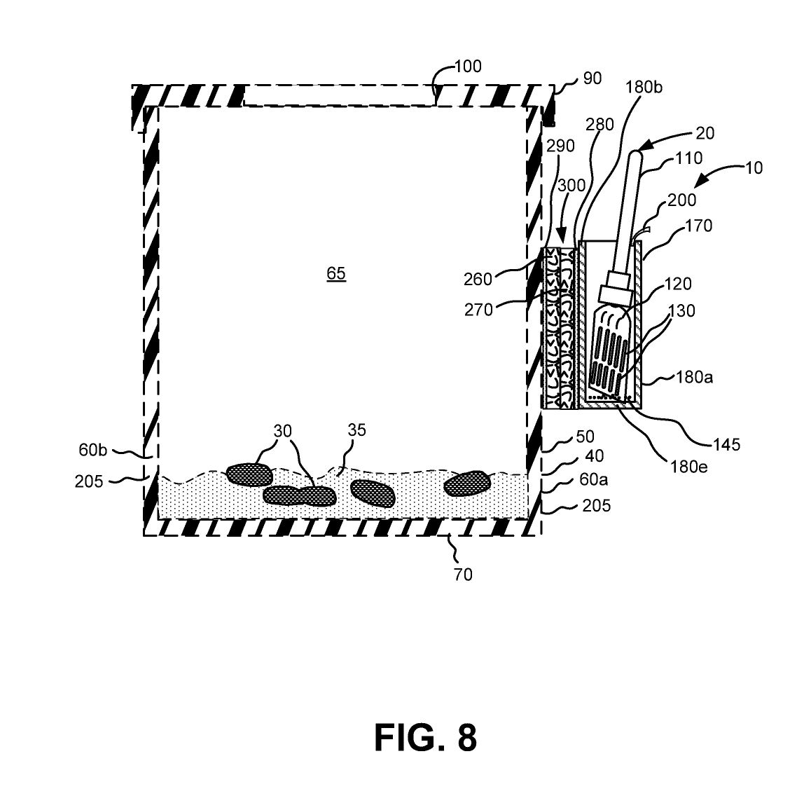

In FIG. 8, there is shown a third embodiment attachment arrangement, generally referred to as 300. Third embodiment attachment arrangement 300 is substantially similar to second embodiment attachment arrangement 250, except first adhesive backing 280 is adhered directly to rear wall 180b of liner 170 for coupling liner 170 directly to support structure 205. Thus, third embodiment attachment arrangement 300 obviates the need for receptacle 140. Therefore, receptacle 140 is omitted. Omission of receptacle 140 reduces material costs of manufacturing litter scoop holder 10 while simultaneously maintaining the ability of liner 170 to be uncoupled from support structure 205 for emptying liner 170 and subsequently recoupled to support structure 205 for storing litter scoop device 20 in liner 170.

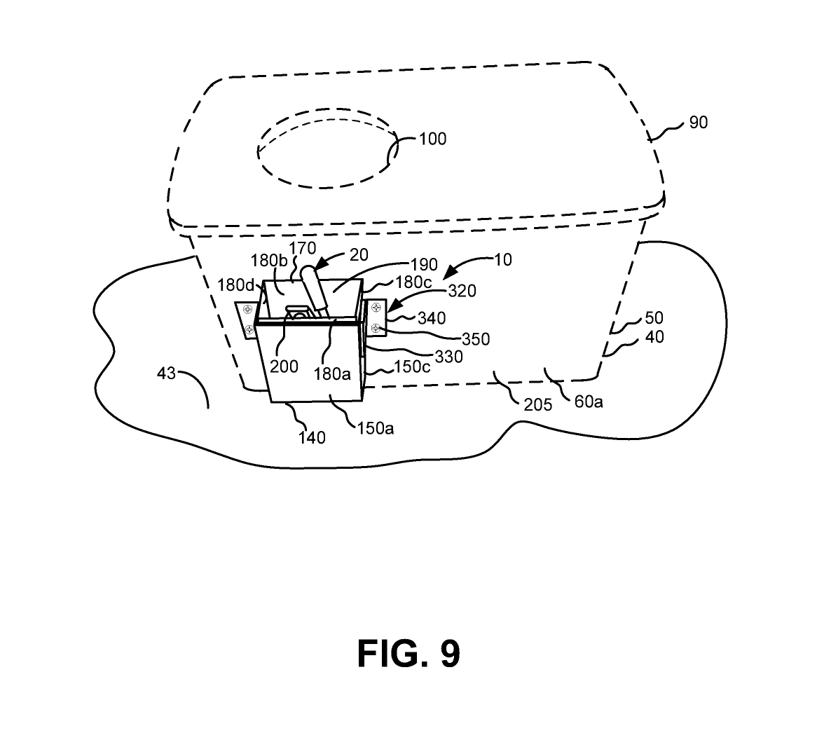

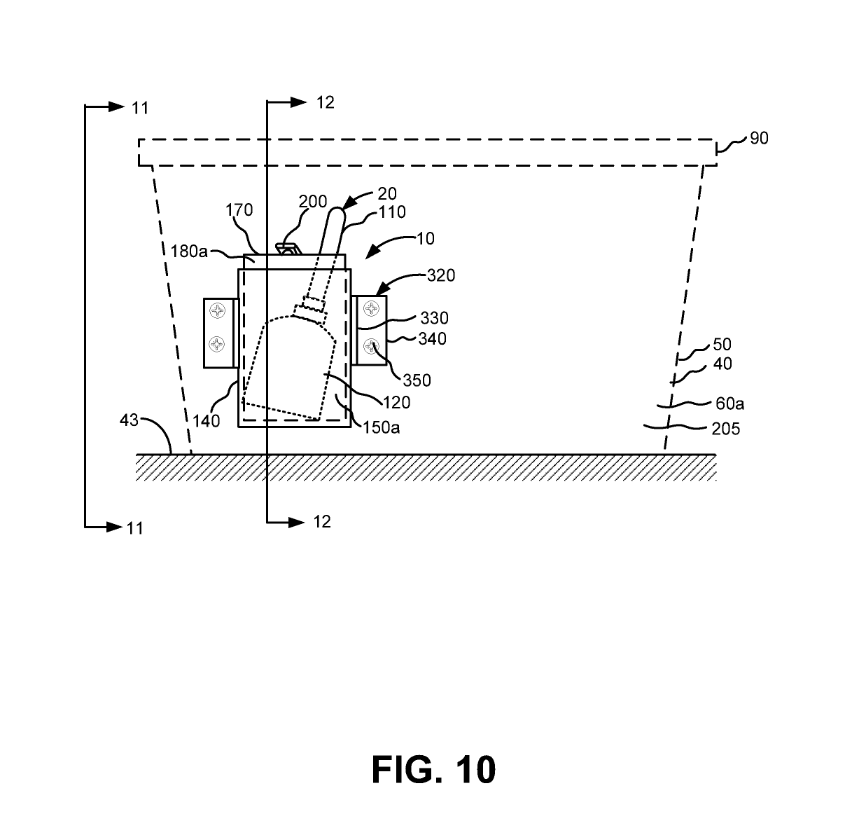

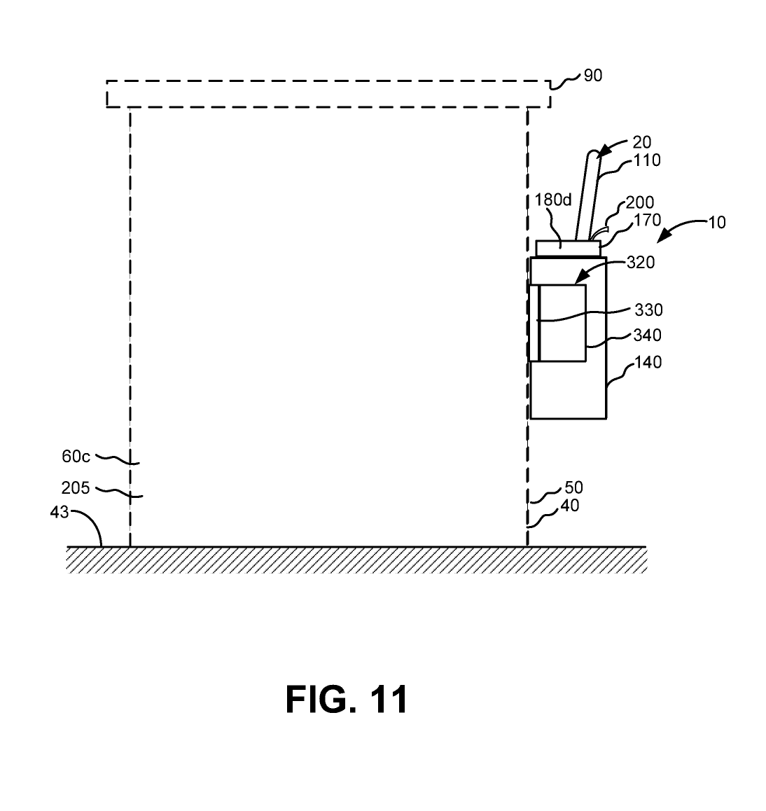

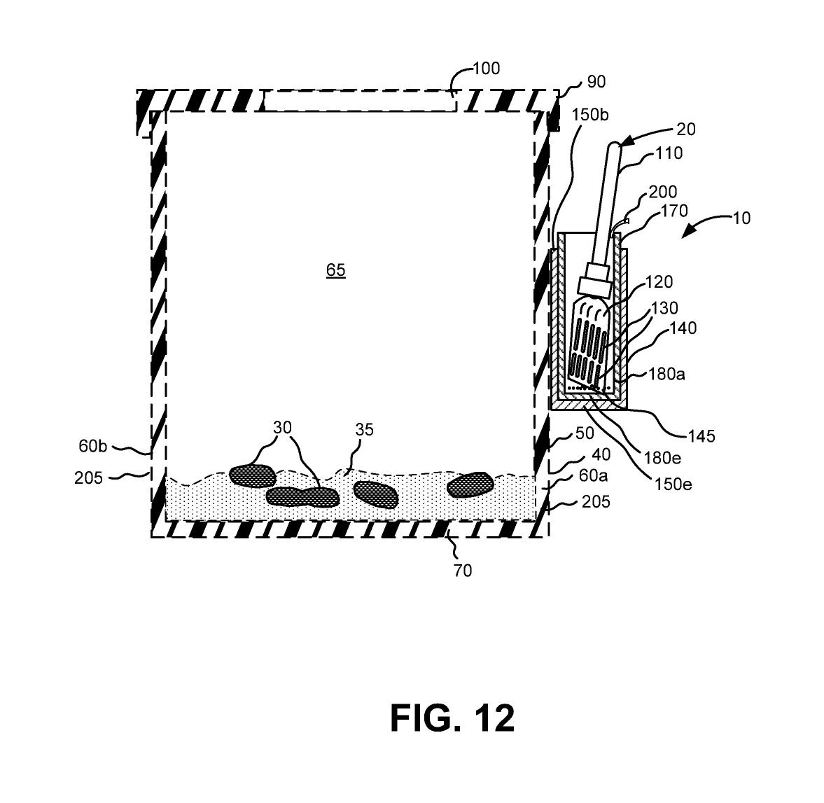

With reference to FIGS. 9, 10, 11 and 12, there is shown a fourth embodiment attachment arrangement, generally referred to as 320, for coupling receptacle 10 to support structure 205. Fourth embodiment attachment arrangement 320 comprises an arm 330 adhesively coupled to right sidewall 150c of receptacle 140 and a flange portion 340 integrally attached to arm 330 and disposed perpendicularly with respect to arm 330. Flange portion 340 is coupled to support structure 205 by means of at least one screw 350. Similarly, another arm 330 is coupled to left sidewall 150d of receptacle 140 and has flange portion 340 coupled to support structure 205 by means of at least one screw 350. In this manner, fourth embodiment attachment arrangement 320 allows receptacle 140 to be coupled to cat litter box 10 by means of screws.

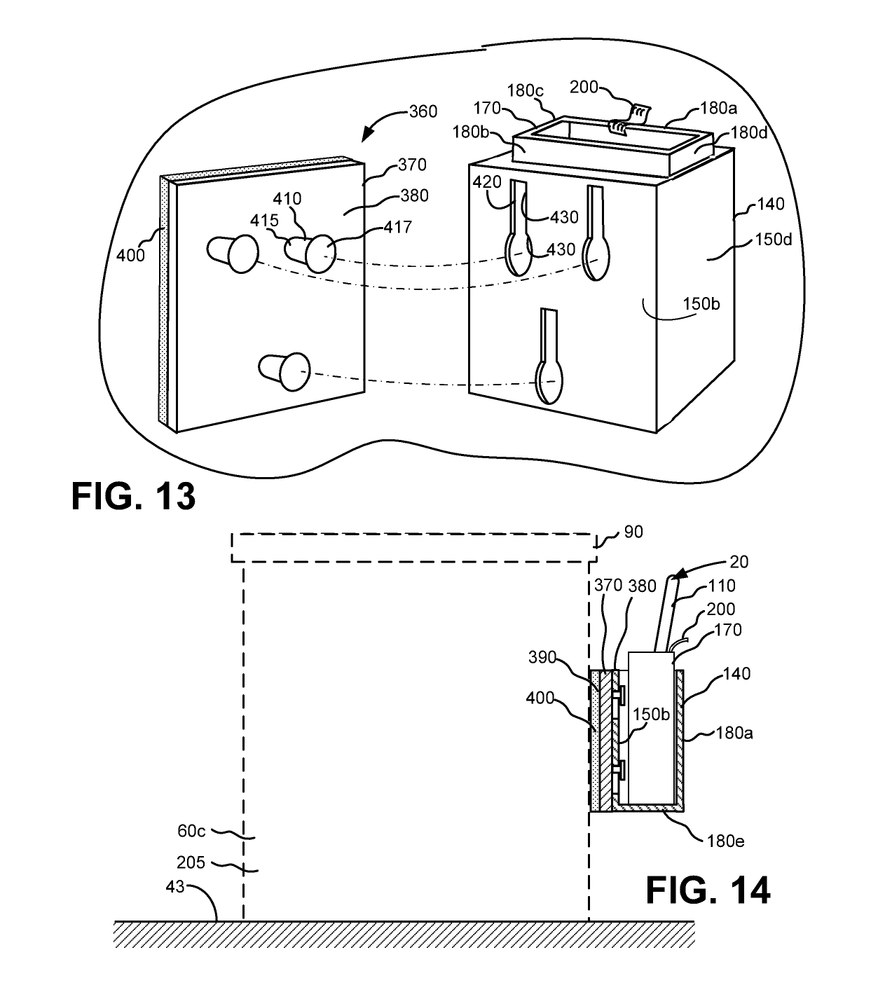

FIGS. 13 and 14 illustrate a fifth embodiment attachment arrangement, generally referred to as 360, for coupling receptacle 140 to support structure 205. Fifth embodiment attachment arrangement 360 comprises a mounting bracket 370 having a front surface 380 and a rear surface 390. Rear surface 390 is adapted to accommodate an adhesive 400. The adhesive 400 may be an epoxy adhesive for allowing attachment arrangement 360 to be easily peeled away from support structure 205, which may be desirable if a worn or damaged receptacle needs replacement. Alternatively, adhesive 400 may be an acrylic adhesive for allowing permanent attachment of mounting bracket 370 to support structure 205. In either case of a peel-away adhesive or a permanent adhesive, use of mounting bracket 370 obviates the need for screw fasteners and therefore obtains a less complex construction requiring fewer components.

Referring again to FIGS. 13 and 14, outwardly projecting from front surface 380 and integrally attached thereto is at least one stud 410 having a shaft portion 415 integrally connected to a bulbous end portion 417 for engaging a corresponding slot 420 defined by rear sidewall 150b of receptacle 140 and that is sized to engage stud 410. Preferably, slot 420 is shaped such that slot 420 has a rectangularly-shaped keyway portion 430 in communication with a circular-shaped hole 440. In use, hole 440 is aligned with bulbous end portion 417 so that bulbous end portion 417 engages hole 440. Receptacle 140 is then moved downwardly so that shaft portion 415 slidably engages keyway portion 430. In this manner, receptacle 140 is releasably secured to mounting bracket 370, and thus to support structure 205. Receptacle 140 is released from mounting bracket 370 by reversing the procedure described immediately hereinabove.

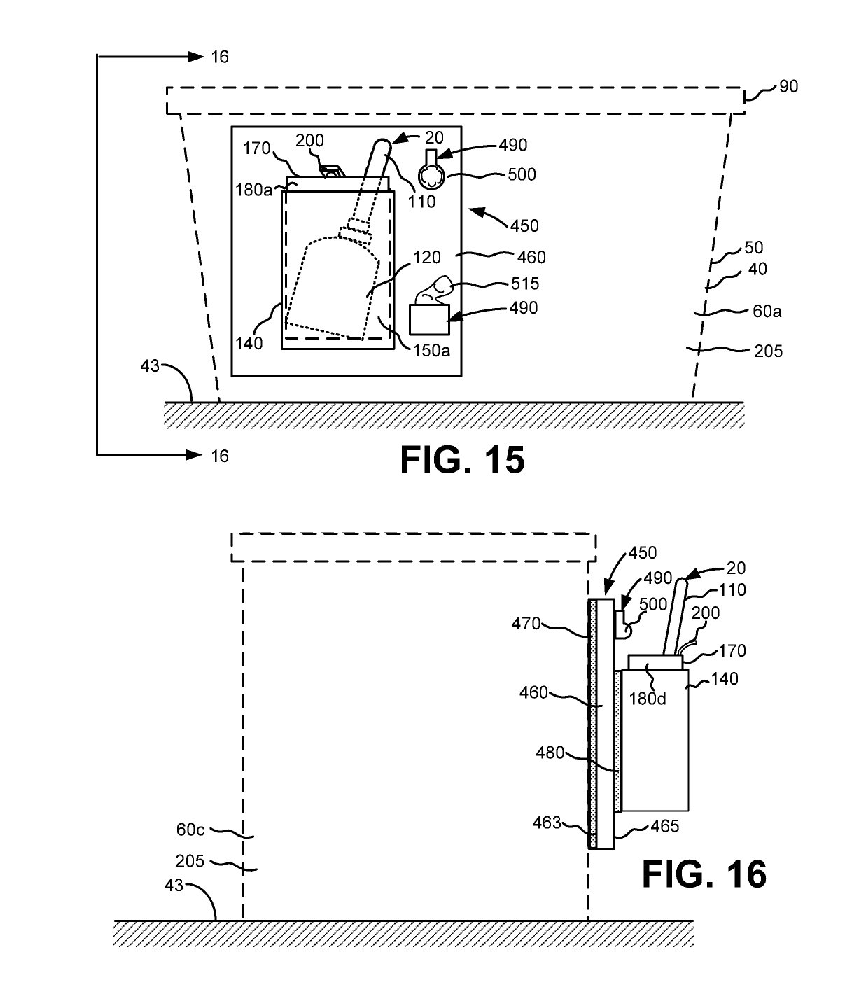

Referring to FIGS. 15 and 16, a sixth embodiment attachment arrangement, generally referred to as 450, is provided for coupling receptacle 10 to support structure 205. Sixth embodiment attachment arrangement 360 comprises a mounting plate 460 having a rear surface 463 and a front surface 465. Mounting plate 460 is adhesively coupled to support structure 205 by means of a first adhesive layer 470 interposed between rear surface 463 and support structure 205. A second adhesive layer 480 is interposed between rear sidewall 150b of receptacle 140 and front surface 465 of mounting plate 460 for adhesively coupling receptacle 140 to mounting plate 460. First adhesive layer 470 may comprise an epoxy adhesive, so that mounting plate 460 can be peeled-away from support structure 205, or an acrylic adhesive for allowing permanent attachment of mounting plate 460 to support structure 205. Similarly, second adhesive layer 480 may comprise an epoxy adhesive, so that receptacle 140 can be peeled-away from mounting plate 460, or an acrylic adhesive for allowing permanent attachment of receptacle 140 to mounting plate 460. In addition, a sanitation accessory, generally referred to as 490, is connected to front surface 465 of mounting plate 460. For example, sanitation accessory may be a dispenser 500 having an odor-removing composition therein for absorbing odors released from contaminated litter particles 145 that temporarily reside in liner 170. The odor-removing composition may be any suitable odor-removing composition, such as zeolite, activated charcoal, silica gel, or the like. Another sanitation accessory 490 may be a replaceable tissue dispenser 510 adapted to dispense a plurality of cloth or paper tissue wipes 515 for wiping, cleaning and sanitizing the interior volume 190 of liner 170 after contaminated litter particles 145 are emptied from liner 170 in the manner previously mentioned. If desired, wipes 515 may be impregnated with a non-toxic solvent, such as ethanol or isopropanol, to assist cleaning and sanitizing of liner 170. Placement of sanitation accessory 490 on mounting plate 490 conveniently locates sanitation accessory 490 for ready access by the user.

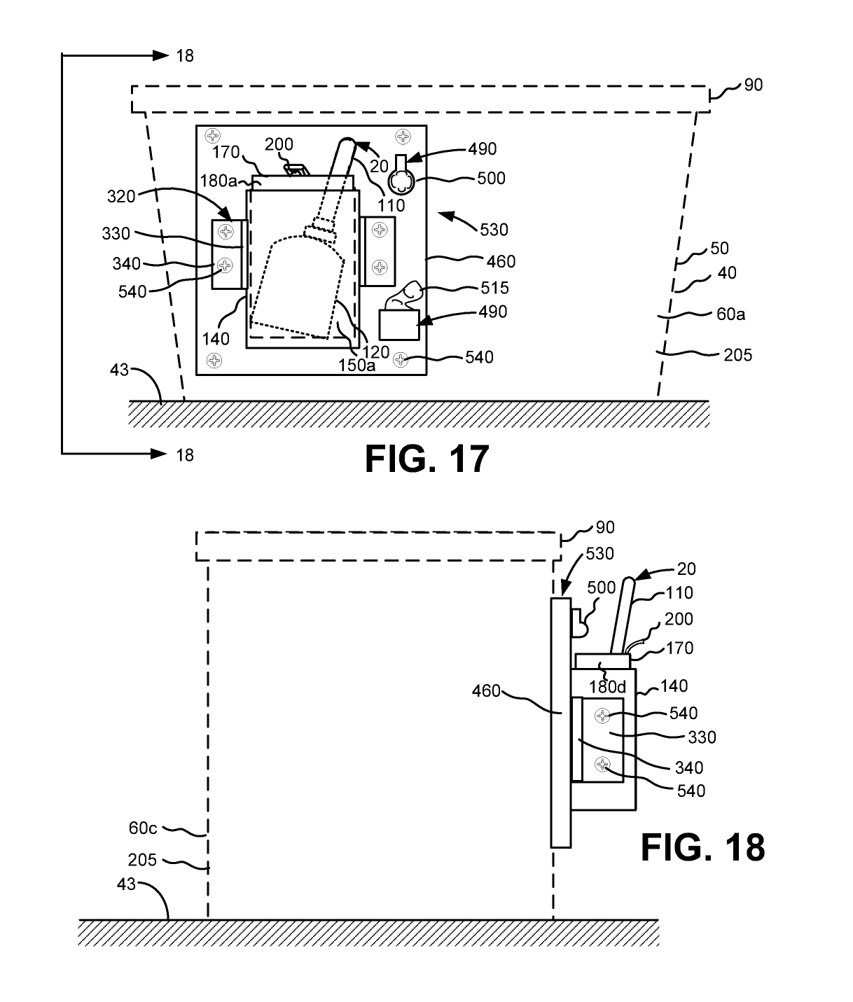

With reference to FIGS. 17 and 18, a seventh embodiment attachment arrangement, generally referred to as 530, is substantially similar to sixth embodiment attachment arrangement 450. However, according to this seventh embodiment attachment arrangement 530, a plurality of screws 540, rather than adhesives, are used to attach mounting plate 460 to support structure 205 and to attach receptacle 140 to mounting plate 460, as shown.

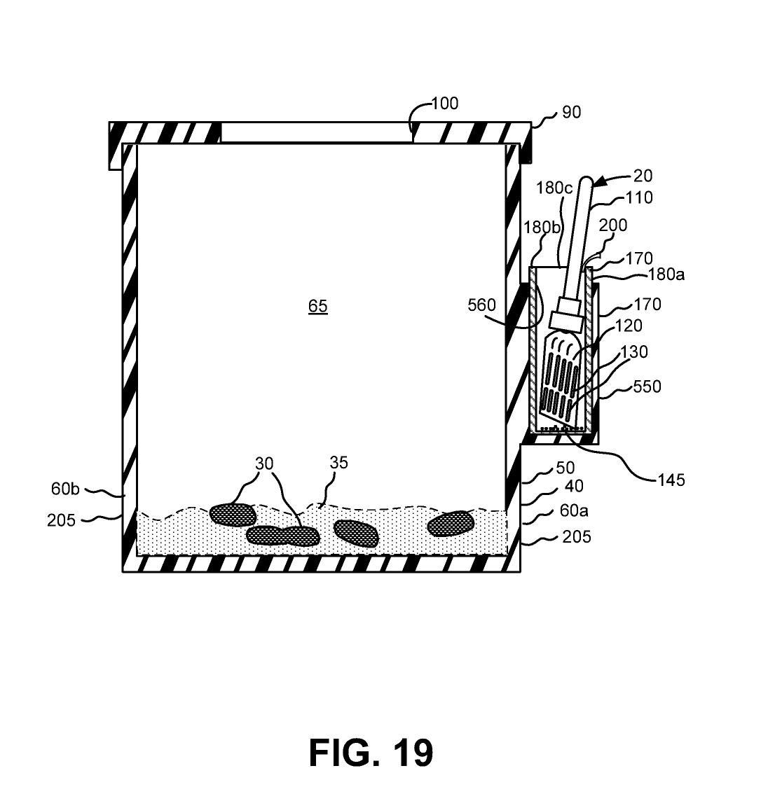

As shown in FIG. 19, another embodiment receptacle 550 is integrally formed with base portion 50 of cat litter box 40, such as being integrally formed with side panel 60a of cat litter box 40, so that receptacle 550 and cat litter box 40 form a single unit. Thus, receptacle 550 is necessarily made of the same material as base portion 50 of cat litter box 40. Receptacle 550 defines a chamber 560 therein for receiving liner 170. This configuration of receptacle 550 and base portion 50 of cat litter box 40 allows base portion 40 and receptacle 550 to be cast from a mold as a single unit, thereby eliminating need for adhesives, hook-and-loop fasteners, and screws in order to couple the receptacle to support structure 205.

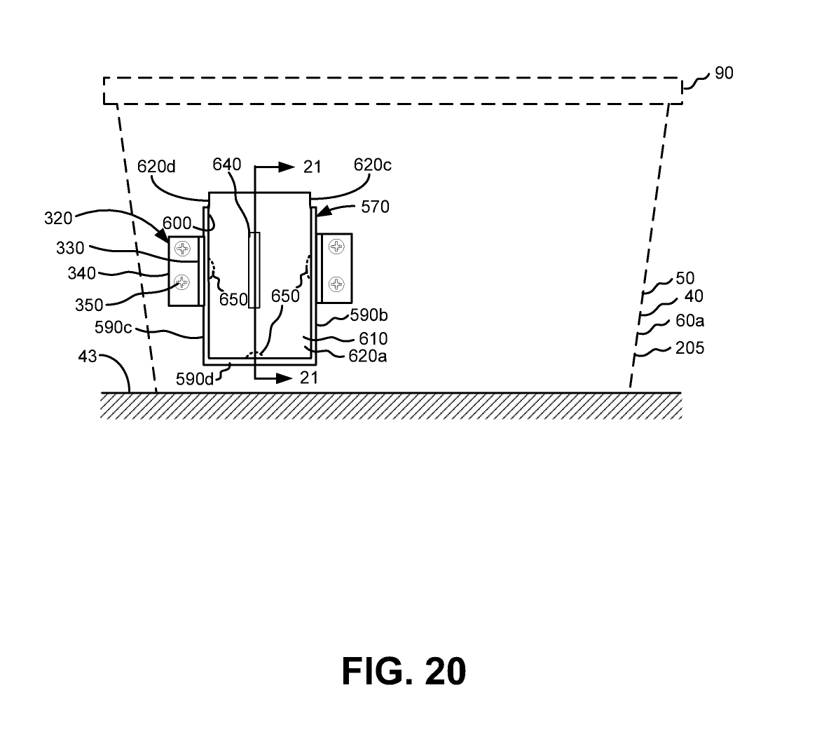

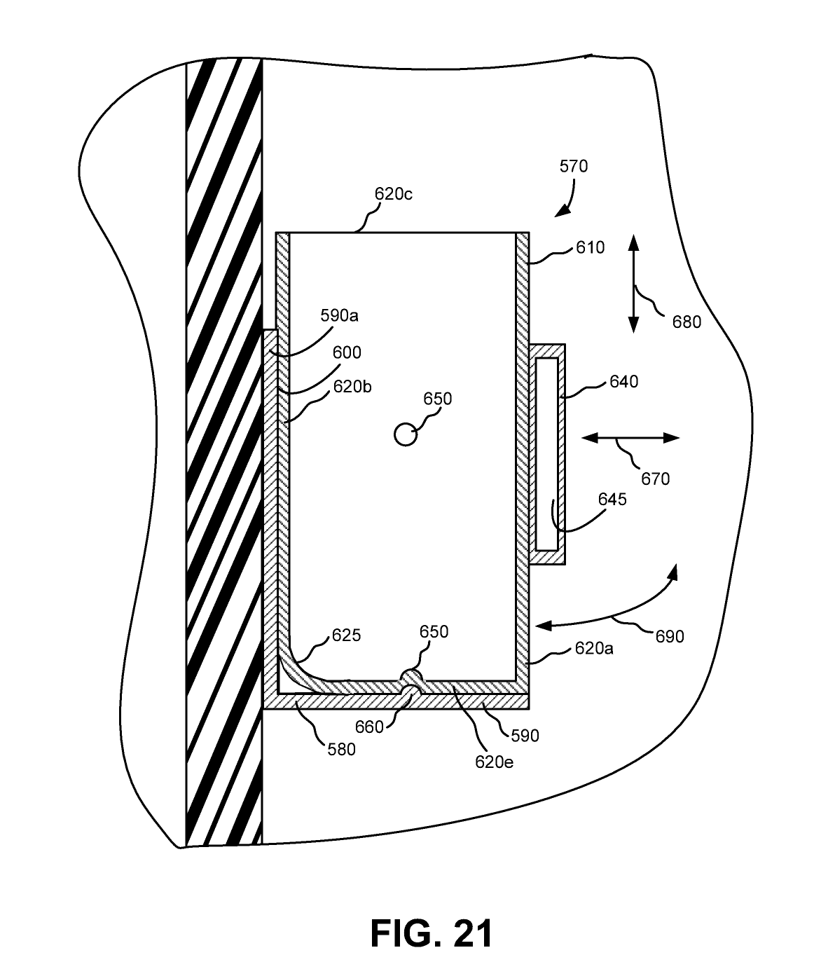

Referring to FIGS. 20 and 21, there is shown a second embodiment litter scoop holder, generally referred to as 570, for holding litter scoop device 20. Litter scoop holder 570 comprises a box-shaped second embodiment receptacle 580 that includes a vertical rear sidewall 590a, a vertical right sidewall 590b, and a vertical left sidewall 590c oppositely disposed with respect to right sidewall 590c and spaced-apart therefrom. Right sidewall 590b and left sidewall 590c are each perpendicular to rear sidewall 590a and integrally attached thereto. Also, a horizontal bottom wall 590d is integrally attached to bottom end portions of sidewalls 590a, 590b, and 590c. As seen in the figures, receptacle 580 lacks a front wall for reasons disclosed presently. In this manner, box-shaped receptacle 580 defines an open alcove 600 therein for receiving a second configuration liner 610.

Still referring to FIGS. 20 and 21, second configuration liner 610 comprises a vertical front wall 620a and a rear wall 620b oppositely disposed with respect to front wall 620a. Rear wall 620b has a curved bottom corner portion 625 for reasons provided hereinbelow. Liner 610 further comprises a vertical right wall 620c and a vertical left wall 620d oppositely disposed with respect to right wall 620c. Right wall 620c and left wall 620d are perpendicular to front wall 620a and rear wall 620b and are integrally connected thereto. In addition, a horizontal bottom wall 620e is integrally connected to walls 620a/620b/620c/620d. Front wall 620a includes a handle 640 that may have a through-hole 645 to receive the user's fingers for facilitating manual insertion of liner 610 into and manual removal of liner 610 from receptacle 580. Walls 620a/620b/620c/620d/620e define a cavity 630 in liner 610 for storing litter scoop device 20 therein.

Referring yet again to FIGS. 20 and 21, each of walls 620c/620d/620e includes at least one dimple or recess 650 sized to matingly engage a respective detent or nodule 660 formed in sidewalls 590b/590c and bottom wall 590d for reasons disclosed presently. In this regard, the combination of recesses 650 and nodules 660 allow liner 610 to be releasably secured within receptacle 580 when liner 610 is placed within receptacle 580. Liner 610 is insertable into receptacle 580 and removable from receptacle 580 by applying sufficient force to overcome the locking force due to engagement of dimples 650 and corresponding nodules 660. Liner 610 is horizontally inserted into or removed from receptacle 580 by manually moving liner 610 in the directions of double headed arrow 670. Alternatively, liner 610 is vertically inserted into or removed from receptacle 580 by manually moving liner 610 in the directions of double headed arrow 680. As another alternative, liner 610 is inserted into or removed from receptacle 580 by manually moving liner 610 at an angle in the directions of double headed arrow 690. In this regard, previously mentioned curved bottom corner portion 625 of rear wall 620b allows liner 610 to be moved along arrow 690 without obstruction or interference from bottom wall 590d of receptacle 580. Allowing the user to insert and remove liner 610 along a plurality of directions provides the user with convenient means for insertion and removal of liner 610 irrespective of the position of the user relative to receptacle 580. The receptacle 580 may be coupled to support structure 205 by any convenient means, such as the previously mentioned fourth embodiment attachment arrangement 320.

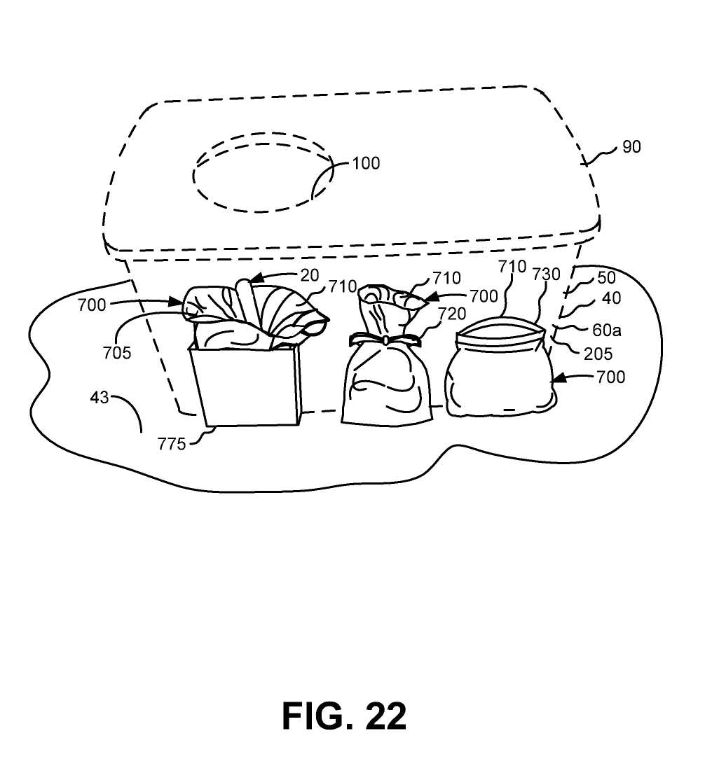

Turning now to FIG. 22, a third configuration liner, generally referred to as 700, is there shown having an open end portion 705 for receiving litter scoop device 20. Third configuration liner 700 is a flexible bag 710 and may be made from any suitable material that will contain contaminated litter particles 145 therein, such as cloth, paper or plastic. After use, open end portion 705 of liner 700 is closed, such as by means of a tie-string 720 or a press-fit closure 730. The press-fit closure 730 may be of a type as found on commercially available plastic bags marketed under the mark “ZIPLOC®” by S.C. Johnson & Son, Incorporated located in Racine, Wis. U.S.A.

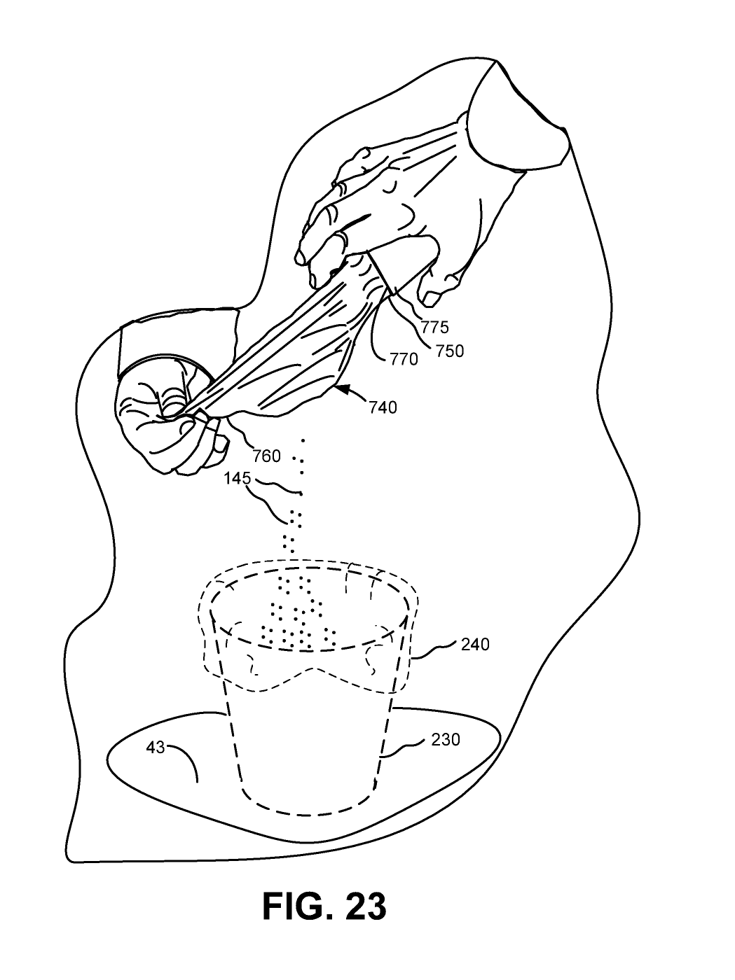

As best seen in FIG. 23, there is shown a fourth configuration liner, generally referred to as 740, being emptied of contaminated cat litter particles 145 into previously mentioned waste container 230 that is lined with sheet 240. Liner 740 is flexible and has an open end portion 750 thereof attached, such as by a suitable adhesive, to an open top end portion 770 of a liner housing 775. Liner housing 775 defines a cavity (not shown) therein. The rest of liner 740 remains unattached inside the cavity defined by liner housing 775. Liner 740 also has a closed end portion 760 that can be grasped and pulled by the user so as to invert the liner 740, for reasons provided presently. In order to empty contaminated cat litter particles 145 from liner 740, the user outwardly pulls closed end portion 760 of liner 740 from the cavity that is defined by liner housing 775, thereby inverting the liner 740 so as to expose the inside of liner 740 to an area outside the cavity. Once outside the cavity, but still attached to open top end portion 770 of liner housing 775, the exposed interior of liner 740 can be cleared of contaminated litter particles 145, cleaned, and then possibly sanitized, such as by means of previously mentioned wipes 515. After cleaning, liner 740 is un-inverted and then pushed back into the cavity that is defined by liner housing 775 and then liner housing 775 can be returned to receptacle 140. Although liner 740 is described hereinabove as being used with receptacle 140, it should be appreciated that liner 740 can be adapted to be used with receptacles 550 and 580, as well.

Illustrative Methods:

An illustrative method associated with an exemplary embodiment for manufacturing the litter scoop holder according to the invention will now be described.

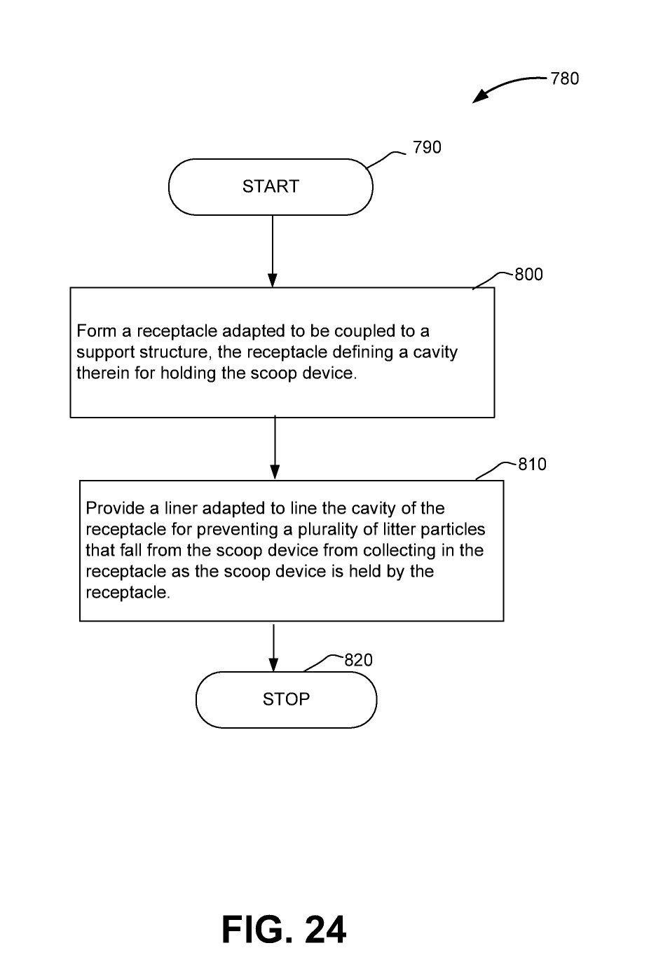

Referring to FIG. 24, an illustrative method, generally referred to as 780, is provided for manufacturing a scoop holder for holding a scoop device adapted to scoop cat litter from a cat litter box. The method starts at a step 790. At a step 800, a receptacle is formed that is adapted to be coupled to a support structure, the receptacle defining a cavity therein for holding the scoop device. At a step 810, a liner is provided that is adapted to line the cavity of the receptacle for preventing a plurality of litter particles that fall from the scoop device from collecting in the receptacle as the scoop device is held by the receptacle. The method stops at a step 820.

Other modifications and implementations will occur to those skilled in the art without departing from the spirit and the scope of the invention as claimed. For example, the receptacle and liner may be made of a transparent material, such as clear plastic, for allowing the user to visually ascertain whether cat litter particles are present to be emptied. As another example, a suction cup affixed to the receptacle and removably connectable to the support structure can be used to removably connect the receptacle to the support structure, rather than using adhesives, hook-and-loop fasteners and screws. Accordingly, the description hereinabove is not intended to limit the invention, except as indicated in the following claims.

The claims will be interpreted according to law. However, and notwithstanding the alleged or perceived ease or difficulty of interpreting any claim or portion thereof, under no circumstances may any adjustment or amendment of a claim or any portion thereof during prosecution of the application or applications leading to this patent be interpreted as having forfeited any right to any and all equivalents thereof that do not form a part of the prior art.

All of the features disclosed in this specification may be combined in any combination. Thus, unless expressly stated otherwise, each feature disclosed is only an example of a generic series of equivalent or similar features.

It is to be understood that while the invention has been described in conjunction with the detailed description thereof, the foregoing description is intended to illustrate and not limit the scope of the invention, which is defined by the scope of the appended claims. Thus, from the foregoing, it will be appreciated that, although specific embodiments of the invention have been described herein for the purpose of illustration, various modifications may be made without deviating from the spirit and scope of the invention. Other aspects, advantages, and modifications are within the scope of the following claims and the present invention is not limited except as by the appended claims.

The specific methods and compositions described herein are representative of preferred embodiments and are exemplary and not intended as limitations on the scope of the invention. Other objects, aspects, and embodiments will occur to those skilled in the art upon consideration of this specification, and are encompassed within the spirit of the invention as defined by the scope of the claims. The invention illustratively described herein suitably may be practiced in the absence of any element or elements, or limitation or limitations, which is not specifically disclosed herein as essential. Thus, for example, in each instance herein, in embodiments or examples of the present invention, the terms “comprising”, “including”, “containing”, etc. are to be read expansively and without limitation. The methods and processes illustratively described herein suitably may be practiced in differing orders of steps, and that they are not necessarily restricted to the orders of steps indicated herein or in the claims.

The terms and expressions that have been employed are used as terms of description and not of limitation, and there is no intent in the use of such terms and expressions to exclude any equivalent of the features shown and described or portions thereof, but it is recognized that various modifications are possible within the scope of the invention as claimed. Thus, it will be understood that although the present invention has been specifically disclosed by various embodiments and/or preferred embodiments and optional features, any and all modifications and variations of the concepts herein disclosed that may be resorted to by those skilled in the art are considered to be within the scope of this invention as defined by the appended claims.

The invention has been described broadly and generically herein. Each of the narrower species and subgeneric groupings falling within the generic disclosure also form part of the invention. This includes the generic description of the invention with a proviso or negative limitation removing any subject matter from the genus, regardless of whether or not the excised material is specifically recited herein.

It is also to be understood that as used herein and in the appended claims, the singular forms “a,” “an,” and “the” include plural reference unless the context clearly dictates otherwise, the term “X and/or Y” means “X” or “Y” or both “X” and “Y”, and the letter “s” following a noun designates both the plural and singular forms of that noun. In addition, where features or aspects of the invention are described in terms of Markush groups, it is intended and those skilled in the art will recognize, that the invention embraces and is also thereby described in terms of any individual member or subgroup of members of the Markush group.

Other embodiments are within the following claims. The patent may not be interpreted to be limited to the specific examples or embodiments or methods specifically and/or expressly disclosed herein. Under no circumstances may the patent be interpreted to be limited by any statement made by any Examiner or any other official or employee of the Patent and Trademark Office unless such statement is specifically and without qualification or reservation expressly adopted in a responsive writing by Applicant(s).

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

1. A scoop holder for holding a scoop device for scooping waste-contaminated cat litter from a cat litter box, the scoop holder comprising:
a receptacle capable of being coupled to a support structure, the receptacle defining a cavity therein for holding the scoop device; and
a liner adapted to line the cavity of the receptacle, thereby preventing litter particles that fall off of the scoop device from collecting in the cavity of the receptacle.

2. The scoop holder of claim 1, wherein the liner is removable and separately cleanable.

3. The scoop holder of claim 1, wherein the liner is a rigid box having an open top end portion for receiving the scoop holder through the open top end portion.

4. The scoop holder of claim 1, further comprising:
an attachment arrangement adapted to couple the receptacle to the support structure.

5. (canceled)

6. The scoop holder of claim 4, wherein the attachment arrangement includes a hook-and-loop fastener.

7. The scoop holder of claim 4, wherein the attachment arrangement includes a screw fastener assembly.

8. The scoop holder of claim 4, wherein the attachment arrangement includes a mounting bracket.

9. The scoop holder of claim 8, wherein the attachment arrangement includes at least one stud attached to the mounting bracket.

10. The scoop holder of claim 9, wherein the receptacle defines at least one slot therein sized to slidably engage the at least one stud for slidably coupling the receptacle to the mounting bracket.

11. The scoop holder of claim 4, wherein the attachment arrangement includes:
a mounting plate; and
at least one sanitation accessory coupled to the mounting plate for reducing odor emanating from the plurality of litter particles, and for cleaning the receptacle.

12. The scoop holder of claim 1, wherein the receptacle is integrally formed with the support structure for defining a single unit including the receptacle and the support structure.

13. The scoop holder of claim 1,
wherein the liner has a plurality of walls having respective ones of a plurality of recesses formed therein; and
wherein the receptacle has a plurality of walls having respective ones of a plurality of detents formed therein, the plurality of detents being releasably engageable with respective ones of the plurality of recesses for releasably coupling the liner to the receptacle.

14. (canceled)

15. The scoop holder of claim 1,
wherein the receptacle has a top end marginal edge portion;
wherein the liner is a flexible bag having an open top end portion attached to the top end marginal edge portion of the receptacle; and
wherein the liner has a closed bottom end portion locatable in a first position within the cavity defined by the receptacle, and the liner is outwardly extendable from the first position to a second position outside the cavity.

16. The scoop holder of claim 1, wherein the support structure is one of:
a side panel of the cat litter box, and
a wall near the cat litter box.

17. A scoop holder for holding a scoop device for scooping cat litter from a cat litter box, the scoop holder comprising:
a receptacle adapted to be coupled to a support structure, the receptacle defining an open alcove accessible through the front of the receptacle as well as the top; and
a liner adapted to line the receptacle, the liner having a handle and adapted to be removably retained by the open alcove of the receptacle, the liner defining a cavity and a top opening for receiving a scoop device, the liner configured to collect therein waste-contaminated litter particles dispersed from the scoop device when placed therein after use, the liner being removable from the receptacle by the handle to discard the collected particles and facilitate its cleaning.

18. (canceled)

19. (canceled)

20. (canceled)

21. The scoop holder of claim 17, wherein the support structure is one of:
a side panel of the cat litter box, and
a wall near the cat litter box.

22. The scoop holder of claim 17, further comprising an attachment arrangement adapted to couple the receptacle to the support structure, that attachment arrangement including screws.

23. The scoop holder of claim 17 wherein the alcove opening of the receptacle is defined by a bottom wall and sidewalls that define an opening large enough to receive the liner, at least one of the walls having detents for receiving nodules disposed on the liner for removably retaining the liner within the alcove opening of the receptacle.
